(19) United States
(12) Patent Application Publication
(10) Pub. No.: US 2018/0101912 A1
(43) Pub. Date: Apr. 12, 2018

(54) SYSTEMS AND METHODS FOR EFFICIENT ONLINE REPEAT-AUCTIONS

(71) Applicants: C. Deniz AKYUZ, NEWTON, MA (US); Lei XIA, Wellesley, MA (US); Tomas REVESZ, Lexington, MA (US); Seth BIRNBAUM, Newton, MA (US)

(72) Inventors: C. Deniz AKYUZ, NEWTON, MA (US); Lei XIA, Wellesley, MA (US); Tomas REVESZ, Lexington, MA (US); Seth BIRNBAUM, Newton, MA (US)

(21) Appl. No.: 15/629,310

(22) Filed: Jun. 21, 2017

Related U.S. Application Data
(60) Provisional application No. 62/405,010, filed on Oct. 6, 2016.

(51) Int. Cl. G06Q 40/08; G06Q 30/08

(52) U.S. Cl. CPC G06Q 40/08; G06Q 30/08

(57) ABSTRACT

Disclosed embodiments include methods, systems, and computer-readable media configured to, for example, implement methods for online repeat-auctions. An exemplary method comprises receiving, via an electronic network, a request from a requestor device associated with an electronic source at least one bid for the request from at least one electronic bidder device. The method further comprises determining at least one quality value for the requestor, which may be based on at least the electronic source associated with the requestor. The method further comprises filtering the at least one bid based on the at least one quality value and at least one quality value. The quality value may be associated with at least one request previously delivered to the at least one electronic bidder. The method further comprises choosing a winning bid of the at least one bid and delivering the request to an electronic bidder device associated with the winning bid.

### RELATED APPLICATIONS

This application claims priority to and incorporates by reference U.S. Provisional Patent Application No. 62/405,010, filed Oct. 6, 2016.

### TECHNICAL FIELD

Embodiments of the present disclosure related to online systems and methods that operate repeat-auctions and adjust bids from bidder systems in order to maximize efficiency in the repeat-auctions.

### BACKGROUND

Online repeat-auctions differ from traditional auctions in numerous ways. In traditional (e.g., non-electronic) auctions, bidders compete to exclusively win a single offer. Once the offer is won by a bidder, the auction is over and a new auction must begin for another offer. Bidders can easily adjust their bids based on factors such as the properties of the items (e.g., quality, brand, style, quantity) and past experience with the items from previous auctions or transactions. These types of auctions are simple to implement, typically do not require computerized implementation, and are relatively straightforward in terms of problems and solutions.

In online repeat-auctions, bidders may repeatedly bid on requests. Bidders may win some requests exclusively, may end up sharing some requests with one or more other bidders, and may not win still other requests. These types of auctions are complicated because of the hybrid win/lose/share nature of the auctions. Due to their complexity, they require implementation using computer and digital data communication technology.

The challenges related to online repeat-auctions differ from challenges in typical (e.g., non-electronic) auctions. For example, the continuous nature of online repeat-auctions may lead to statistics-based behavior by bidders, whereby they measure and optimize the performance of their campaigns in a marketplace, and modify their bids as appropriate. Bidders may measure and collect aggregated statistics such as average cost per bid or average cost per sale. The quality of such online auctions comes down to fairness—that is, whether the auction provides a stream of correctly matched bidders to correctly matched offerors, all while ensuring the bids affect the win rate without altering the quality of the matches.

In these auctions, it is imperative to provide enough information to bidders so they can set the correct bid on each auction. Given that these auctions occur on electronic networks, the “source” of the offerors (i.e., how the offeror arrives at the auction) may be included in this information. Typical systems for online repeat-auctions lack a reliable channel to provide this necessary information. Typical systems also lack a reliable manner of learning quality features of the offerors and their alignment to each bidder, based on the properties of the offeror. Learning these quality features would be desirable as it would enable the bidders and the auction systems themselves to efficiently match bidders to offerors.

The present disclosure provides devices, methods, systems, and computer-readable media to solve these and other issues.

### SUMMARY

Disclosed embodiments include methods, systems, and computer-readable media configured to, for example, implement methods for online repeat-auctions. An exemplary method comprises receiving, via an electronic network, a request from a requestor device associated with an electronic source at least one bid for the request from at least one electronic bidder device. The method further comprises determining at least one quality value for the requestor, which may be based on at least the electronic source associated with the requestor. The method further comprises filtering the at least one bid based on the at least one quality value and at least one quality value. The quality value may be associated with at least one request previously delivered to the at least one electronic bidder. The method further comprises choosing a winning bid of the at least one bid and delivering the request to an electronic bidder device associated with the winning bid.

Systems and computer-readable media implementing the above method are also provided.

Aspects of the disclosed embodiments may include non-transitory and/or tangible computer-readable media that stores software instructions that, when executed by one or more processors, are configured to and capable of performing and executing one or more of the methods, operations, and the like consistent with the disclosed embodiments. Also, aspects of the disclosed embodiments may be performed by one or more processors configured as special-purpose processor(s) based on software instructions that are programmed with logic and instructions that perform, when executed, one or more operations consistent with the disclosed embodiments. Moreover, aspects of the disclosed embodiments may be implemented on specialized (rather than generic) equipment or devices.

It is to be understood that both the foregoing general description and the following detailed description are exemplary and explanatory only and are not restrictive of the claimed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is an exemplary network diagram, consistent with disclosed embodiments.

FIG. 2 is an exemplary high-level flow diagram depicting an example repeat-auction, consistent with disclosed embodiments.

FIG. 3 is an exemplary embodiment of auction system, consistent with disclosed embodiments.

FIG. 4 is an exemplary method of implementing a repeat-auction, consistent with disclosed embodiments.

FIG. 5 is an exemplary electronic device, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Embodiments of the present disclosure are directed to: systems, methods, and computer-readable media for implementing online repeat-auctions. Such online repeat-auctions involve, in part, directing requestors (such as consumers) to bidders (such as good/service providers) to ensure a desired average level of “quality” or fairness to each bidder. One non-limiting example of such an online repeat-auction is an auction for insurance. A consumer may use a device to navigate to an auction website looking to purchase insurance from an insurance provider. Bidders may interact with the auction system to repeatedly bid on numerous requestors. A bidder may win an auction, in which case the bidder and the consumer are put into contact to finalize the sale of insurance. The bidder may also lose the auction or may share the consumer with another bidder.

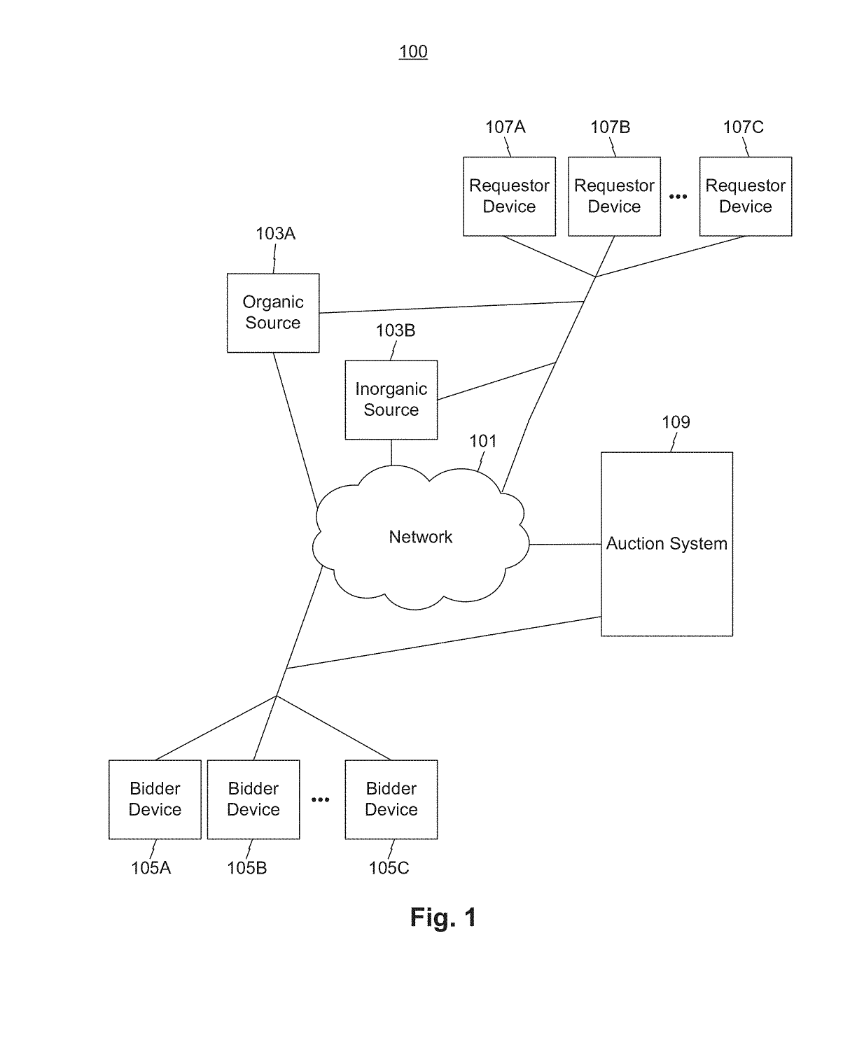

FIG. 1 is an exemplary diagram 100 consistent with the disclosed embodiments. Diagram 100 depicts network 101, at least one organic source 103A, at least one inorganic source 103B, bidder devices 105A-105C, requestor devices 107A-107C, and auction system 109. While certain devices and systems are depicted in singular or plural forms in diagram 100, it is to be understood that other embodiments are possible, and that each of the devices and systems depicted in diagram 100 may be present in singular or plural form in certain embodiments.

Network 101, in some embodiments, represents at least one electronic data network which interconnects electronic devices. For example, network 101 may be implemented as one or more of the Internet, an intranet, one or more private links, or the like. Network 101 may also be implemented as one or more wired or wireless networks. In some embodiments, each of the devices and systems connected to network 101 may communicate using known protocols, such as TCP/IP (Transmission Control Protocol/Internet Protocol) and HTTP (Hypertext Transfer Protocol). For example, a user of requestor device 107A may select on an advertisement displayed on a webpage hosted by a web server (e.g., organic source 103A). This advertisement may be presented as part of a web page and delivered to bidder device by inorganic source 1038. Once the user of requestor device 107A selects the advertisement, requestor device 107A opens a web page hosted by auction system 109 and enables bidding on an auction

Organic source 103A and inorganic source 1038, in some embodiments, represent digital traffic sources through which bidder devices are referred to (e.g., navigate to) auction system 109. For example, a requestor device 107A may arrive at auction system 109 through one of organic source 103A or inorganic source 1038 by selecting an advertisement which leads the requestor device 107A, searching for a good offered by bidder device(s) 107A-C, or the like. Each of organic source 103A and inorganic source 1038 may comprise at least one source of digital traffic, such as a website, a social media network, an advertising network, a search engine, a physical item (e.g., a QR code that leads to a website), or the like.

Each source through which requestor devices are referred to auction system 109 may be classified (e.g., by auction system 109) as “organic” or “inorganic” based on the particulars of that source and the mechanism by which the requestor device was referred to auction system 109. For example, organic source 103A, in some embodiments, represents a source through which requestor devices 107A-107C are referred to auction system 109 without compensation by auction system 109 and/or bidder devices 105A-105C. For example, if requestor device 107A reaches auction system 109 through a posting on a social media network (e.g., by interacting with a Facebook™ update posted by auction system 109 or a tweet on Twitter™ posted by bidder device 105B), that social media network would be classified as an organic source 103A. Other “organic” sources (also referred to as “unpaid” or “uncompensated” sources) may include, for example, email marketing systems, search engines which refer digital traffic by way of search engine optimization (SEO), social media posts or networks, or the like.

In contrast, inorganic source 103B, in some embodiments, represents a source through which requestor device 107A-107C are referred to auction system 109 based on compensation by auction system 109 and/or bidder devices 105A-105C. For example, if requestor device 107B reaches auction system 109 through a paid advertisement displayed as part of search results generated by a search engine (known as “search engine marketing” or SEM), that search engine would be classified as an inorganic source 103B. Other “inorganic” sources (also referred to as “paid,” “promoted,” or “compensated” sources) may include, for example, advertising networks, targeted social media or search engine advertisements, other Pay Per Click (PPC) systems, or the like.

Bidder devices 105A-105C, in some embodiments, may be implemented as one or more computerized systems for placing bids on repeat-auctions operated by auction system 109. As one example, bidder device 105A may be operated by a good/service provider, such as a manufacturer or an insurance provider. Bidder device 105A may be configured to generate a bid for a current or future auction operated by auction system 109. In some embodiments, bidder device 105A may receive an indication from auction system 109 indicating that an auction is occurring or will occur soon, and in response, generate a bid for that auction. In other embodiments, bidder device 105A may generate and send a bid without receiving any indications from auction system 109.

Bidder device 105A may also be configured to receive an indication that its bid has won a repeat-auction operated by auction system 109. Such an indication may include information about the won auction (e.g., contact information for a requestor device 107A, price of bid, etc.)

In some embodiments, each of bidder device 105A-105C may be operated by a separate entity (and thus may be implemented as separate computerized systems). In other embodiments, one or more of bidder devices 105A-105C may be operated by the same entity, for example, to enable that entity to submit multiple bids for a single auction. (In these embodiments, one or more of bidder devices 105A-105C may be implemented as separate applications operating on one or more devices, threads of the same application operating on a single device, instances of the same application operating on a single device, or the like).

Bidder devices 105A-105C may generate bids based on information about the request. For example, bidder devices 105A-105C may determine its optimal bid based on the source through which a requestor was referred to auction system 109 (e.g., organic vs. inorganic), based on information about the requestor (e.g., identity, demographics, location, past history of purchases/interaction), based on content of the request (e.g., the particular good/service requested).

Requestor devices 107A-107C, in some embodiments, may be implemented as one or more computerized systems for offering something as part of a repeat-auction operated by auction system 109. For example, requestor device 107A may be operated by or on behalf of a consumer that is seeking to receive offers (in the form of bids) for a good/service that the consumer wishes to purchase.

In one example implementation, diagram 100 may represent a network arrangement for implementing online repeat-auctions that connect insurance providers (i.e., bidder devices 105A-105C) with consumers looking to purchase insurance (i.e., requestor devices 107A-107C). In this situation, consumers may request a quote for insurance given particular constraints (e.g., age of the consumer, type of insurance, amount of coverage) and the bidder devices 105A-105C “bid” on the consumers in an attempt to obtain the consumers as paying customers of their insurance policies. In this implementation, there is likely an infinite number of consumers that can be acquired by any one insurance provider, as the insurance providers have a virtually unlimited supply of insurance policies.

As another example implementation, diagram 100 may represent a network arrangement for implementing online repeat-auctions that connect suppliers (i.e., bidder devices 105A-105C) with consumers or businesses looking to purchase supplies (i.e., requestor devices 107A-107C). In this situation, consumers may request a quote for an order of supplies given particular constraints (e.g., the number of supplies, desired brands or qualities, shipping speed) and the bidder devices 105A-105C “bid” on the consumers in an attempt to obtain the consumers as purchasing customers. In this implementation, there is likely a finite number of consumers that can be acquired by any one supplier, as the suppliers have a finite number of supplies for sale.

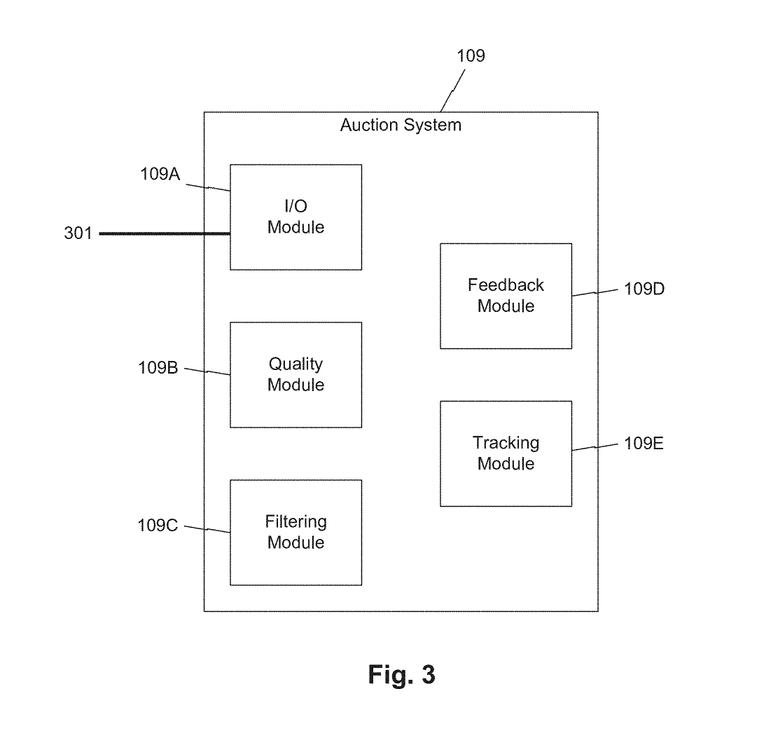

Auction system 109, in some embodiments, may be implemented as a system that operates one or more repeat-auctions. In some embodiments, auction system 109 may be implemented using a plurality of modules that each perform a finite set of tasks that, in conjunction, work to operate a repeat-auction (including initialization of the repeat-auction, running of the repeat-auction, and finalizing the results of the repeat-auction. (One embodiment of some modules of auction system 109 is discussed below with respect to FIG. 3.)

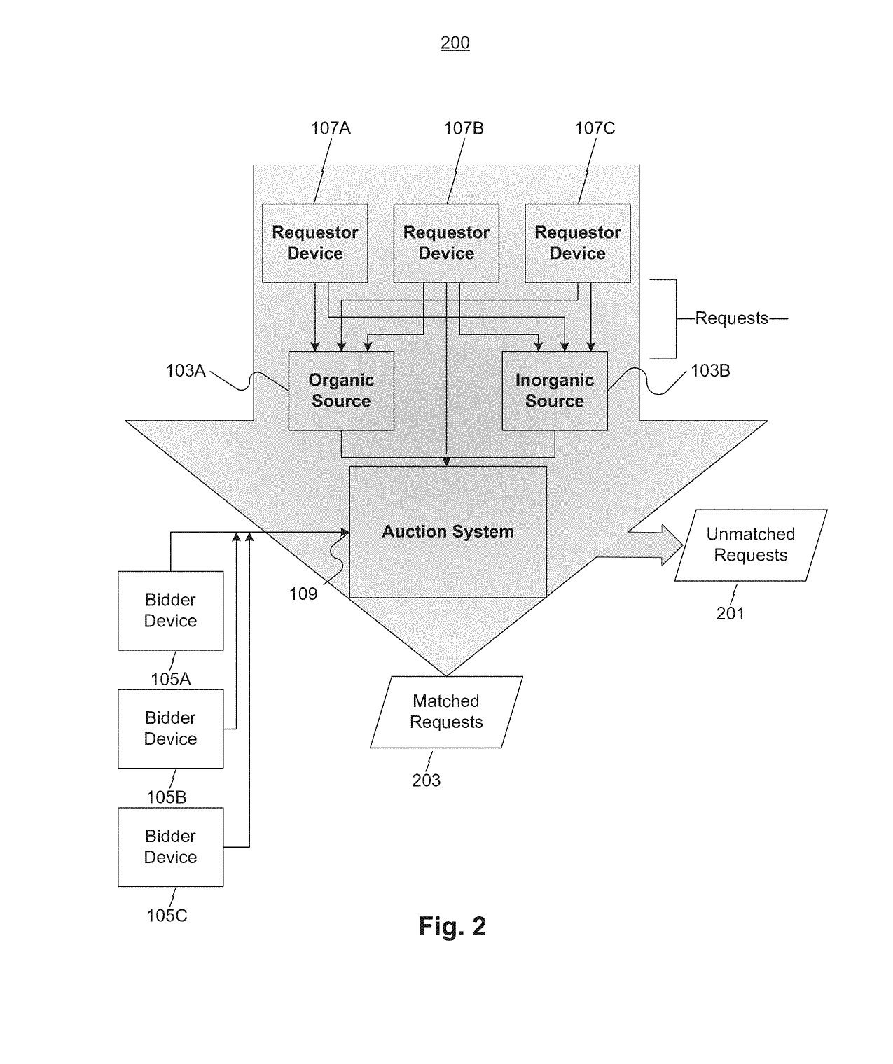

FIG. 2 is a high-level flow diagram depicting an example repeat-auction 200, consistent with disclosed embodiments. Example repeat-auction 200 may begin with one or more of requestor devices 107A-107C requesting a good or service from auction system 109. Requestor devices 107A-107C may request the good or service directly (e.g., by initiating a request to auction system 109) or indirectly (e.g., by navigating to one of an organic source 103A or inorganic source 1038 that refers the requestor device to auction system 109, or by requesting the good or service from a third party which forwards the request to auction system 109). The request may include information about requestor devices 107A-107C, such as a requested item or service from a bidder. Auction system 109 may then forward an indication to bidder devices 105A-105C, and may include information received from a requestor devices 107A-107C. Auction system 109 may then operate the repeat-auction. Operating the repeat-auction may comprise matching each request from a requestor device 107A-107C with as many bids from bidder devices 105A-105C as possible. Requests may then be classified as one of unmatched requests 201 (e.g., if a request from a requestor device is not won by a bidder) or matched requests 203 (e.g., if a request from a requestor device is won by a bidder)

At the end of the repeat-auction, auction system 109 may send a communication to any requestor device(s) whose requests make up the set of unmatched requests 201, indicating that the request was not won by any of bidder devices 105A-105C and that the requestor device(s) may send these requests again. (In alternative embodiments, auction system 109 may operate a new repeat-auction with the unmatched requests 201.) Auction system 109 may also send a communication to any requestor device(s) whose requests make up the set of matched requests 203, indicating the bidder device that won the repeat-auction for the requestor device's request.

FIG. 3 is an exemplary embodiment of auction system 109, consistent with disclosed embodiments. In some embodiments, auction system 109 may comprise one or more interconnected modules implemented as software, hardware, firmware, or a combination thereof, that operate repeat-auctions consistent with the disclosed embodiments. Exemplary FIG. 3 depicts I/O (input/output) module 109A, quality module 1098, filtering module 109C, feedback module 109D, tracking module 109E, and data link 301. While FIG. 3 depicts exemplary modules 109A-109E, one of skill will understand that other modules and other configurations are possible.

I/O Module 109A, in some embodiments, may be configured to enable communication between auction system 109 and other devices and systems, such as those depicted in FIG. 1. I/O Module 109A may be connected to network 101 via, for example, data link 301. Data link 301 may be implemented as one or more of a wired or wireless network connection to one or more other devices, systems, or networks.

Quality Module 1098 may be configured to determine a “quality” value for each incoming requestor (e.g., a customer seeking a service or good from a bidder). In some embodiments, the terms “quality” and “quality value” refer to a measurement related to a particular requestor (such as a consumer) that relates in part to how likely that requestor is to make a purchase from a particular bidder. This value may be used to measure a sense of “fairness” for ensuring that all bidders are able to participate and win some level of repeat-auctions. For example, the quality value can be used to ensure that a bidder cannot win all repeat-auctions by simply outbidding every other bidder every time. The use of a “quality value” may be used to ensure a fairer distribution and a more efficient repeat-auction process.

In some embodiments, the quality value associated with a requestor may be associated with a set of actions performed by a requestor. Such actions may comprise predetermined types of interactions of the requestor with the bidder, the bidder's services, or the bidder's goods. These actions may, in some embodiments, provide a measure of how much the requestor has interacted with the bidder in the past and how closer the requestor is/was to making a purchase from a bidder. In this sense, the “quality value” is related to a “value to the bidder.” Continuing the above insurance auction example, one sample action type, “quote-started,” may represent whether the requestor has shown interest in working with the bidder by submitting contact information online or over the phone. Another example action, “quote-complete,” may represent whether the consumer has continued far enough in the process of purchasing insurance to receive a quote from the bidder. A “purchase” action may, in some embodiments, be the most valuable action to the bidder. Each of these actions may relate to a different “quality value” (per bidder, per industry, or the like) given that each one has a different (potential or actual) value to the bidder.

The types of actions and the value of these actions to the bidder may depend on the industry and the type of business. For example, in the insurance business, where leads may be followed up by emails or telemarketing, a “quote-start” action may be a valuable action for the bidder. In other business, such as where bidders sell goods online, a “quote-start” action may be of less value to that bidder.

Data used to determine quality of a particular action with respect to a particular requestor—e.g., how much interaction a particular bidder receives from such actions—may be received via an automated or a manual process. One example manner of receiving such data may comprise automated processes, such as by using cookies or other signatures/tracking identifiers known in the art. Another exemplary manner of receiving this data may comprise inserting tracking data (e.g., a tracking code) into communications sent between devices, to enable auction system 109 to track how often requestor devices 107A-107C respond to offers from bidder devices 105A-105C. Another example may comprise manual processes, by which the value of each action may be manually input or selected.

Other information related to qualify includes the particular source by which a requestor device was referred to auction system 109. Incorporation of the sourcing method into the quality assignment allows mixing consumers from various sources into a steady flow of biddable units with constant quality. In some embodiments, the sourcing method may factor into the quality value of a requestor using an independent multiplicative factor or a non-linear function. The output of such a process to assign quality may be represented mathematically as a computed quality score Qᵢⱼₖ for each consumer Cᵢⱼ from source Sᵢ for a given bidder Bₖ. Different algorithms factors that go into the computation may result in different quality scores. For example, if the requestor's demographic information factors into the computation, then similar consumers may have the same quality for a given bidder regardless of the source Sᵢ; i.e., Qₘⱼₖ=Qₙⱼₖ (where m and n signify different sourcing methods for the same consumer, j, and given bidder, k). In other embodiments, where the sourcing method is used as the only quality differentiation, the algorithm would assign different quality scores for similar consumers from different sources for the same bidder; i.e., Qₘⱼₖ≠Qₙⱼₖ. In these embodiments, consumers from the same source would have the same quality score for a given bidder; i.e., Qᵢₘₖ=Qᵢₙₖ where m and n signify different consumers from the same source, i.

Filtering Module 109C may be configured to filter out particular bidders and/or modify received bids in order to equally distribute requests to bidders. In some embodiments, filtering module 109C may be configured to filter bids based on a hard (i.e., strict) quality threshold. For example, if the delivered quality is below a set threshold for a bidder, that bidder can only win consumers whose quality assignment is higher than the threshold. In some embodiments where filtering is based on a hard threshold, a bidder will not participate in the auction if the quality assigned to the requestor is below the bidder's quality threshold and the total quality delivered to that bidder is below that threshold. This may be represented mathematically as bidder k not participating if

Qᵢⱼₖ<τₖ && Dₖ<τₖ, where

Qᵢⱼₖ is the assigned quality to the requestor Cᵢⱼ from source Sᵢ with intrinsic properties j for the bidder k;
τₖ is the quality threshold for the bidder k; and
Dₖ is the total quality delivered to bidder k in a time period.

A variation on these embodiments using a hard threshold to filter may comprise filtering on a threshold based on post-delivery quality. For example, if the bidder k winning the given requestor Cᵢⱼ would lower the bidder k's delivered quality under its quality threshold, then that bidder will not participate in the auction; this may be represented mathematically as bidder k not participating if

D′ₖ<τₖ,
where Dk would be the total future quality delivered to bidder k,
if bidder k were to win auction for requestor Cᵢⱼ.

Another type of filtering may comprise a probabilistic filter. In some embodiments, this probabilistic filter may be configured to cause the auction system 109 to disqualify a bidder from bidding on a requestor whose quality value is below the bidder's threshold. The probability of disqualification could be, for example, a function of the threshold value and the assigned quality of the consumer. One manner of implementing such a filter may comprise bidder k not participating with probability ρᵢⱼₖ, where

$${ρ}_{ijk} = \{ \begin{matrix}0 , & {D}_{k} \geq {τ}_{k} , or {Q}_{ijk} \geq {τ}_{k} \\ 1 - {e}^{- α \cdot ( {τ}_{k} - {Q}_{ijk} )} , & otherwise\end{matrix}$$

A variation on these probability embodiments may comprise disqualifying a bidder from participating for requestors with assigned quality below the threshold, if the total quality delivered to the bidder is close to the quality threshold. The probability of disqualification could be, for example, a function of the threshold value, the assigned quality of the requestor, and the total quality delivered to the bidder. For example, implementing such a filter may comprise bidder k not participating with probability ρᵢⱼₖ, where

$$\begin{matrix}{ρ}_{ijk} = {e}^{- α \cdot \frac{{Q}_{ijk} \cdot {D}_{k}}{{τ}_{k}^{2}}} & \\ or & \\ {ρ}_{ijk} = {e}^{- \frac{α \cdot {Q}_{ijk} + β \cdot {D}_{k}}{{τ}_{k}^{2}}} & \\ with & \\ α , β \geq 0 & \end{matrix}$$

In other embodiments, the bid may be altered as a function of the target quality and the currently delivered quality.

In still other embodiments, auction system 109 may also choose to promote a low bidder to win a high quality requestor if the delivered quality is below a set threshold. The method of measuring the delivered quality may also differ per requestor or per bidder.

In any of the above-described embodiments, it should be noted that a quality value assigned to a requestor may not be permanent. For example, the quality value for a particular requestor may vary from one time period to the next. For example, this time period could be per day (e.g., from midnight to midnight, local time of auction server 109), per last 24 hours, per last 7 days, week-to-day, month-to-day, or the like. If the filtering decision is a soft bid-strength modifier based on the delivered quality and the quality of the requestor, the amount of delivered requestor units may be also leveraged in the decision.

One embodiment of filtering module 109C may comprise utilizing a bid modifier. Instead of, for example, disqualifying a bidder, its bids can be lowered to reduce its probability to win. The resulting effective bid is then used in competition with other bidders, and the actual payout (e.g., the amount paid from the bidder to auction system 109 or requestor device 105A-C) may be the modified bid, the actual placed bid, or another value. For example, a modified bid may be represented mathematically as:

bᵢⱼₖ′=mᵢⱼₖbⱼₖ
Where kᵢⱼₖ′ is the effective bid;
mᵢⱼₖ is the bid modifier for requestor Cᵢⱼ from source Sᵢ; and
bⱼₖ is the actual bid for the requestor, independent of source Sᵢ and assigned quality Qᵢⱼₖ.

Filtering module 109C may determine the bid modifier, mᵢⱼₖ, in a number of ways, including:

$$\begin{matrix}{m}_{ijk} = \{ \begin{matrix}1 , & if {D}_{k} \geq {τ}_{k} OR {Q}_{ijk} \geq {τ}_{k} \\ {e}^{- α \cdot ( {τ}_{k} - {Q}_{ijk} )} & , else\end{matrix} & \\ or & \\ {m}_{ijk} = 1 - {e}^{- α \frac{{Q}_{ijk} \cdot {D}_{k}}{{τ}_{k}^{2}}} & \\ or & \\ {m}_{ijk} = 1 - {e}^{- \frac{α \cdot {Q}_{ijk} + β \cdot {D}_{k}}{{τ}_{k}^{2}}} & \end{matrix}$$

Feedback module 109D may be configured to analyze data from various sources. The feedback measured by the feedback sources may be direct feedback from the bidders per won unit. In other embodiments, feedback may comprise aggregate feedback over a specified set. Surveys (e.g., sent to requestors) can also be used as feedback sources.

A statistical aggregation of delivered quality for the bidders may also take many forms. One form of statistical aggregation would be a statistical average of quality Dₖ, for a given window:

$${D}_{k} = \frac{{\sum }_{i , j ∈ {W}_{ijk}} {Q}_{ijk}}{{\sum }_{i , j ∈ {W}_{ijk}} 1} ;$$

where
Wᵢⱼₖ specifies the requestors i delivered to bidder k within a defined window (e.g., 24 hours) from source j.

Another example of an aggregation is one where the older events are counted weighed less compared to the latest events. One such example is an exponential decaying average, represented mathematically as:

Dₖ′=α·Qᵢⱼₖ+(1−α)·Dₖ; where
Dₖ′ is the updated total quality delivered to bidder k after it won the bid for consumer i with quality Qᵢⱼₖ;
Dₖ is the delivered quality before that delivery; and
α ∈ [0,1] is a decaying constant.

Other embodiments of maintaining and gathering feedback data are possible as well.

Tracking module 109E may be configured to track each won bid. For example, tracking module 109E may implement an accounting system to track which bids win (and which bids lose), as well as the features of each winning (and losing) bid. This enables deeper analysis to determine what features cause win/loss of a bid. Tracking module 109E may also keep track of the statistical aggregation of delivered quality for each bidder. Cookies may also be used to confirm that a requestor device 107A lands on a website of a bidder device 105A after that bidder submitted a winning bid.

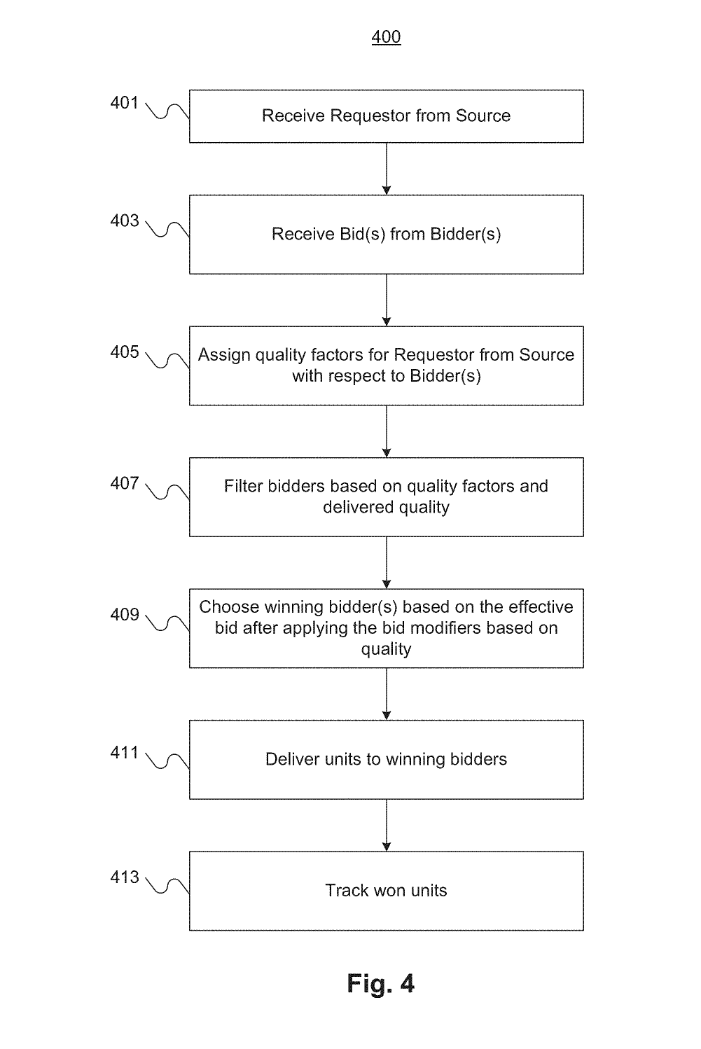

FIG. 4 is an exemplary method 400 of implementing a repeat-auction, consistent with disclosed embodiments.

Method 400 begins with step 401. In step 401, auction system 109 receives a request. Receiving the request may comprise directly receiving a request from a requestor device 107A—for example, through an organic source 103A or inorganic source 1038 that received a click or interaction from a requestor device (e.g., 107A). The step of receiving the request may comprise receiving one or more of an identity of the requestor, demographics of the requestor, anonymized information of the requestor, details of a request of the requestor (e.g., a desired product or service, a desired price, or terms and conditions of the request), or the like.

Method 400 may then proceed to step 403. In step 403, auction system 109 may receive one or more bids from one or more bidder devices 105A-105C. In some embodiments, before receiving bids in step 403, auction system 109 may send a communication to bidder devices 105A-105C indicating the receipt of the request from the requestor in step 401. This communication may include details received in the request (e.g., identity, demographics, details of the request). In other embodiments, auction system 109 may receive bids from bidder devices 105A-105C without prompting from the auction system 109. For example, bidder devices 105A-105C may periodically send open bids to auction system 109.

Method 400 may then proceed to step 405. In step 405, auction system 109 may assign a quality value to the request received in step 401. For example, auction system 109 may assign a quality value based on the source that referred requestor device 107A to auction device 109, based on past actions taken by that requestor device 107A (e.g., purchases or quote requests) or other actions. As discussed above with respect to FIG. 3, this quality assessment step may be performed by quality module 1098, or may in other embodiments be performed by a different module or other system.

Method 400 may then proceed to step 407. In step 407, auction system 109 may filter the received bids. As discussed above with respect to filtering module 109C, filtering received bids may comprise discarding bids based on delivered quality, using a bid modifier to affect received bids, or the like.

Method 400 may then proceed to step 409. In step 409, auction system 109 may choose at least one winning bidder based on the filtering performed in step 407 and the quality assessment in step 405. For example, auction system 109 (e.g., an electronic processor in auction system 109) may rank the bids in order of value and choose the highest bid as the “winning” bid. Auction system 109 may then debit or charge the bidder device associated with the winning bid by an amount (such as the value of the bid, the value of the first losing or second-highest bid, a modified value of the winning bid, or the like).

Method 400 may then proceed to step 411. In step 411, auction system 109 may deliver requests to winning bidder devices, for example, by delivering a phone number or email address associated with a requestor to a bidder (for later contact) or by showing contact information to a requestor for one or more bidders (e.g., in a ranked list of advertisements for each bidder). In some embodiments, tracking module 109E and/or I/O module 109A may deliver the requests to winning bidder devices.

Method 400 may then proceed to step 413. In step 413, auction system 109 may track the results of the won bids. For example, as explained above, tracking module 109E may implement an accounting system to track which bids win (and which bids lose), as well as the features of each winning (and losing) bid. This enables deeper analysis to determine what features cause win/loss of a bid. Cookies may also be used to confirm that a requestor device 107A lands on a website of a bidder device 105A after that bidder submitted a winning bid.

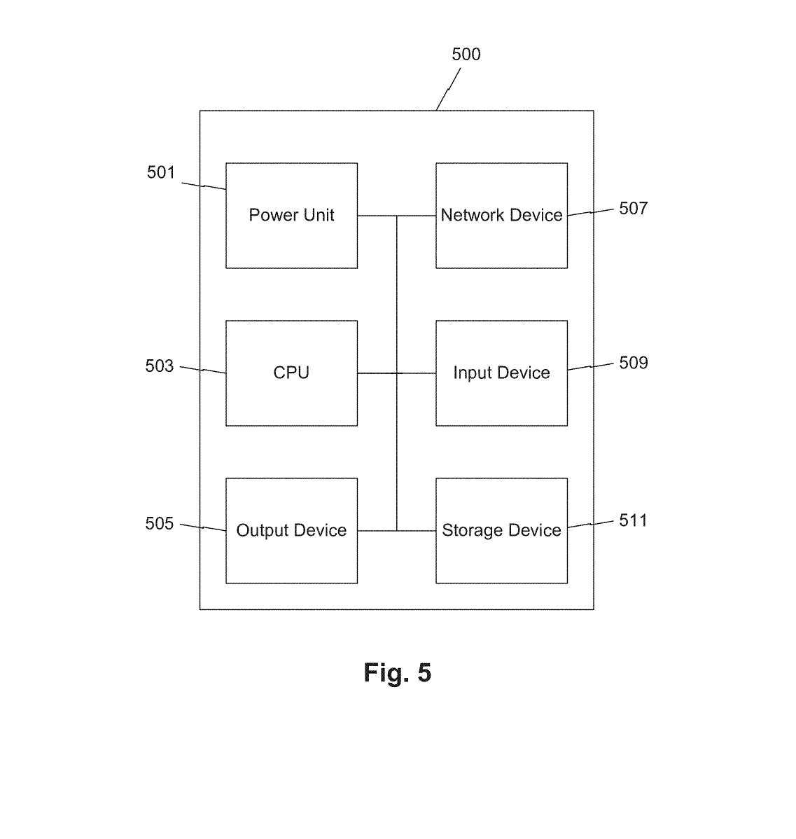

FIG. 5 depicts an exemplary electronic device 500, consistent with disclosed embodiments. Each component depicted in the preceding figures, including organic source(s) 103A, inorganic source(s) 1038, bidder device(s) 105A-105C, requestor device(s) 107A-107C, or auction system 109, may be implemented in part as illustrated in computer system 500. In some embodiments, the components in FIG. 5 may be duplicated, substituted, or omitted. Each of the components in FIG. 5 can be connected to one another using, for example, a wired interconnection system such as a bus (shown in FIG. 5).

System 500 comprises power unit 501. Power unit 501 can be implemented as a battery, a power supply, or the like. Power unit 501 provides the electricity necessary to power the other components in system 500. For example, CPU 503 needs power to operate. Power unit 501 can provide the necessary electric current to power this component.

System 500 contains a Central Processing Unit (CPU) 503, which enables data to flow between the other components and manages the operation of the other components in computer system 500. CPU 503, in some embodiments, can be implemented as a general-purpose processor (such as an Intel- or AMD-branded processor), a special-purpose processor (for example, a graphics-card processor or a mobile processor), or any other kind of processor that enables input and output of data.

System 500 also comprises output device 505. Output device 505 can be implemented as a monitor, printer, speaker, plotter, or any other device that presents data processed, received, or sent by computer system 500.

System 500 also comprises network adapter 507. Network adapter 507, in some embodiments, enables communication with other devices that are implemented in the same or similar way as computer system 500. Network adapter 507, in some embodiments, may allow communication to and/or from a network such as the Internet. Network adapter 507 may be implemented using any or all of known or as-yet-unknown wired or wireless technologies (such as Ethernet, 802.11a/b/g/n (aka Wi-Fi), cellular (e.g. GSM, CDMA, LTE), or the like).

System 500 also comprises input device 509. In some embodiments, input device 505 may be any device that enables a user or other entity to input data. For example, input device 509 could be a keyboard, a mouse, or the like. Input device 509 can be used to control the operation of the other components illustrated in FIG. 5.

System 500 also includes storage device 511. Storage device 511 stores data that is usable by the other components in system 500. Storage device 511 may, in some embodiments, be implemented as a hard drive, temporary memory, permanent memory, optical memory, or any other type of permanent or temporary storage device. Storage device 511 may store one or more modules of computer program instructions and/or code that creates an execution environment for the computer program in question, such as, for example, processor firmware, a protocol stack, a database management system, an operating system, or a combination thereof.

The term “processor system,” as used herein, refers to one or more processors (such as CPU 503). The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible and/or non-transitory computer-readable storage mediums, one skilled in the art will appreciate that these aspects can also be stored on and executed from many types of tangible and/or non-transitory computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

1. A system for performing online repeat-auctions, comprising:
a storage device comprising instructions; and
at least one electronic processor configured to execute the instructions to implement an input/output module, a quality module, a filtering module, and a tracking module,
wherein the at least one electronic processor executes the instructions:
to cause the input/output module to receive, via an electronic network, (1) a first request from a device of a requestor, the request being associated with an electronic source and (2) a plurality of bids for the request from at least one electronic device of an electronic bidder;
to cause the quality module to determine at least one quality value for the requestor based on at least the electronic source associated with the request;
to cause the filtering module to filter the plurality of bids based on the at least one quality value for the requestor and at least one quality value associated with at least one request previously delivered to at least one electronic device of an electronic bidder;
to perform an auction in order to choose a winning bid of the plurality of bids; and
to cause the tracking module and input/output module to deliver the first request to an electronic device of an electronic bidder associated with the winning bid.

2. The system of claim 1, wherein filtering comprises discarding at least one bid based on a comparison of the quality value for the requestor with an aggregation of at least one quality value associated with at least one request previously delivered to the at least one electronic bidder.

3. The system of claim 1, wherein filtering comprises modifying at least one bid based on a function of a threshold associated with the at least one electronic bidder, the quality value for the requestor, and at least one quality value associated with at least one request previously delivered to the at least one electronic bidder.

4. The system of claim 1, wherein receiving a request from a requestor device comprises receiving the request from the electronic source.

5. The system of claim 4, wherein determining the at least one quality value for the requestor comprises:
determining the electronic source from which the request was referred;
classifying the electronic source based on whether the referral was based on a paid or unpaid referral; and
assigning a quality value to the requestor based on the classifying.

6. The system of claim 1, wherein the at least one quality value associated with the at least one requestor previously delivered to the at least one electronic bidder comprises a weighted average of at least two quality values, each quality value associated a requestor previously delivered to the at least one electronic bidder

7. The system of claim 1, wherein:
the auction comprises a repeat-auction for insurance;
the requestor device is associated with a consumer; and
the at least one electronic bidder device is operated by an insurance company.

8. A method for performing online repeat-auctions, comprising:
receiving, via an electronic network, a first request from a device of a requestor, the request being associated with an electronic source;
receiving, via the electronic network, a plurality of bids for the request from at least one electronic device of an electronic bidder;
determining at least one quality value for the requestor based on at least the electronic source associated with the request;
filtering the plurality of bids based on the at least one quality value for the requestor and at least one quality value associated with at least one request previously delivered to at least one electronic device of an electronic bidder;
performing an auction in order to choose a winning bid of the plurality of bids; and
delivering the first request to an electronic device of an electronic bidder associated with the winning bid.

9. The method of claim 8, wherein filtering comprises discarding at least one bid based on a comparison of the quality value for the requestor with an aggregation of at least one quality value associated with at least one request previously delivered to the at least one electronic bidder.

10. The method of claim 8, wherein filtering comprises modifying at least one bid based on a function of a threshold associated with the at least one electronic bidder, the quality value for the requestor, and at least one quality value associated with at least one request previously delivered to the at least one electronic bidder.

11. The method of claim 8, wherein receiving a request from a requestor device comprises receiving the request from the electronic source.

12. The method of claim 11, wherein determining the at least one quality value for the requestor comprises:
determining the electronic source from which the request was referred;
classifying the source based on whether the referral was based on a paid or unpaid referral; and
assigning a quality value to the requestor based on the classifying.

13. The method of claim 8, wherein the at least one quality value associated with the at least one requestor previously delivered to the at least one electronic bidder comprises a weighted average of at least two quality values, each quality value associated a requestor previously delivered to the at least one electronic bidder

14. The method of claim 8, wherein:
the auction comprises a repeat-auction for insurance;
the requestor device is associated with a consumer; and
the at least one electronic bidder device is operated by an insurance company.

15. A non-transitory computer-readable medium storing instructions, the instructions configured to cause at least one electronic processor to perform a method for performing online repeat-auctions, the method comprising:
receiving, via an electronic network, a request from a device of a requestor, the request being associated with an electronic source;
receiving, via the electronic network, a plurality of bids for the request from at least one electronic device of an electronic bidder;
determining at least one quality value for the requestor based on at least the electronic source associated with the request;
filtering the plurality of bids based on the at least one quality value for the requestor and at least one quality value associated with at least one request previously delivered to at least one electronic device of an electronic bidder;
performing an auction in order to choose a winning bid of the plurality of bids; and
delivering the first request to an electronic device of an electronic bidder associated with the winning bid.

16. The medium of claim 15, wherein filtering comprises discarding at least one bid based on a comparison of the quality value for the requestor with an aggregation of at least one quality value associated with at least one request previously delivered to the at least one electronic bidder.

17. The medium of claim 15, wherein filtering comprises modifying at least one bid based on a function of a threshold associated with the at least one electronic bidder, the quality value for the requestor, and at least one quality value associated with at least one request previously delivered to the at least one electronic bidder.

18. The medium of claim 15, wherein receiving a request from a requestor device comprises receiving the request from the electronic source.

19. The medium of claim 18, wherein determining the at least one quality value for the requestor comprises:
determining the electronic source from which the request was referred;
classifying the source based on whether the referral was based on a paid or unpaid referral; and
assigning a quality value to the requestor based on the classifying.

20. The medium of claim 15, wherein the at least one quality value associated with the at least one requestor previously delivered to the at least one electronic bidder comprises a weighted average of at least two quality values, each quality value associated a requestor previously delivered to the at least one electronic bidder
